(19) United States
(12) Patent Application Publication
(10) Pub. No.: US 2008/0313146 A1
(43) Pub. Date: Dec. 18, 2008

(54) CONTENT SEARCH SERVICE, FINDING CONTENT, AND PREFETCHING FOR THIN CLIENT

(75) Inventors: Curtis G. Wong, Medina, WA (US); Dale A. Sather, Seattle, WA (US); Kenneth Reneris, Clyde Hill, WA (US); Thaddeus C. Pritchett, Edmonds, WA (US); Behrooz Chitsaz, Bellevue, WA (US); Talal Ali Batrouny, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/764,037

(22) Filed: Jun. 15, 2007

(51) Int. Cl. G06F 17/30

(52) U.S. Cl. 707/3; 707/E17.009

(57) ABSTRACT

The claimed subject matter provides a system and/or method that effectuates and facilitates search of multimedia content. The disclosed system can include components that extract closed captioned information from video content, index the extracted information against frames of corresponding video content, and utilize associated metadata, tags, and indexes to search through the extracted information and respond to a submitted query with identified video content.

### BACKGROUND

Advancements in networking and computing technologies have transformed many aspects of everyday life and in particular have transformed computers from being low performance/high cost devices capable of performing elementary word processing and simplistic/basic mathematical computations and manipulations to high-performance/low-cost machines capable of a myriad of disparate and highly complex functions and utilities. For instance, computers have become household staples rather than luxuries, educational tools, and/or entertainment centers, and can provide individuals and corporations tools to manage and forecast finances, control operations such as heating, cooling, lighting and security, and store records, and images in a permanent and reliable medium. As further illustration, at the consumer level computing devices can be employed to aid users in paying bills, tracking expenses, communicating nearly instantaneously with friends and/or family across vast distances by way of e-mail and/or instant messaging, obtaining information from networked the repositories, and numerous other functions/activities.

As computing and network technologies have evolved and have become more robust, secure and reliable, more consumers, wholesalers, retailers, entrepreneurs, educational institutions, and the like have and are shifting business paradigms and are employing the Internet to perform business rather than utilizing traditional means. For example, today many television broadcasting services and systems can utilize networking and computing technologies to not only produce and create television shows, but also to disseminate such multimedia content to users situated on many broadcast media. Nevertheless, as compared to only an handful of television networks being available in the past, television networks and the content that have been able to marshal, produce and disseminate has proliferated to the extent where currently there are hundreds of sources, and the number of such sources keep increasing. Accordingly, searching through such vast amounts of media content can be a daunting task for most users using currently available technologies.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

As compared to only a handful of television networks being available in the past, television content (and the like) is now provided by hundreds of sources (e.g., via cable or satellite channels, web-based channels, video posting web sites, etc.), and the number of such sources keep increasing. Accordingly searching through such vast amounts of media has become increasingly difficult using conventional technology.

The subject matter as claimed relates to a system that facilitates enhanced searching through video content and the like. Closed captioning text or metadata are employed because they are in an easily searchable format—text strings, for example. A user, for instance, may request information on earthquakes, and the system searches closed captioned strings for words relating to earthquakes, and delivers associated video content.

Closed captioning can be handled differently by different media. The captioning for movies is normally done well in advance, while a live sporting event is typically dubbed live. Other media may fall somewhere in between these two extremes, but nevertheless the subject matter as claimed can adapt to handle any situation. Accordingly, a useful system feature that can be adopted by the claimed subject matter includes separating closed captioning data from regular television data. For instance, in a direct television feed, captioning information is bundled together with the rest of the video data, so for each frame of video there are perhaps a few words or none at all, depending on the timing of the subtitles. A great obstacle to conventional searching systems to date has been the fact that they must mine through all the data to reach the captioning data corresponding to this search request. By separating the two data sets or streams as in the claimed subject matter in advance of the search request, can dramatically reduce search times. Moreover, in the case of live captioning, data can be retrieved by either camping on a certain channel and aggregating data, or by simultaneously scanning across multiple channels. Such data can then be persisted and thereafter used for current and future searches.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates and facilitates media content searches in accordance with the claimed subject matter.

FIG. 2 provides an alternative and/or additional depiction of a system that effectuates and facilitates media content searches in accordance with one aspect of the claimed subject matter.

FIG. 3 provides a more detailed depiction of an illustrative central server that effectuates and facilitates media content searches in accordance with an aspect of the claimed subject matter.

FIG. 4 illustrates a more detailed depiction of a search and extraction component that can be employed in accordance with an aspect of the claimed subject mater.

FIG. 5 illustrates a system implemented on a machine that effectuates and facilitates media content searches in accordance with an aspect of the claimed subject matter.

FIG. 6 provides a further depiction of a machine implemented system that effectuates and facilitates media content searches in accordance with an aspect of the subject matter as claimed.

FIG. 7 illustrates yet another aspect of the machine implemented system that effectuates and facilitates media content searches in accordance with an aspect of the claimed subject matter.

FIG. 8 depicts a further illustrative aspect of the machine implemented system that effectuates and facilitates media content searches in accordance with an aspect of the claimed subject matter.

FIG. 9 illustrates another illustrative aspect of a system implemented on a machine that effectuates and facilitates media content searches in accordance of yet another aspect of the claimed subject matter.

FIG. 10 depicts yet another illustrative aspect of a system that effectuates and facilitates media content searches in accordance with an aspect of the subject matter as claimed.

FIG. 11 illustrates a flow diagram of a machine implemented method that effectuates and facilitates media content searches in accordance with an aspect of the claimed subject matter.

FIG. 12 illustrates a flow diagram of a machine implemented methodology that effectuates and facilitates media content searches in accordance with an aspect of the claimed subject matter.

FIG. 13 illustrates a block diagram of a computer operable to execute the disclosed system in accordance with an aspect of the claimed subject matter.

FIG. 14 illustrates a schematic block diagram of an exemplary computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

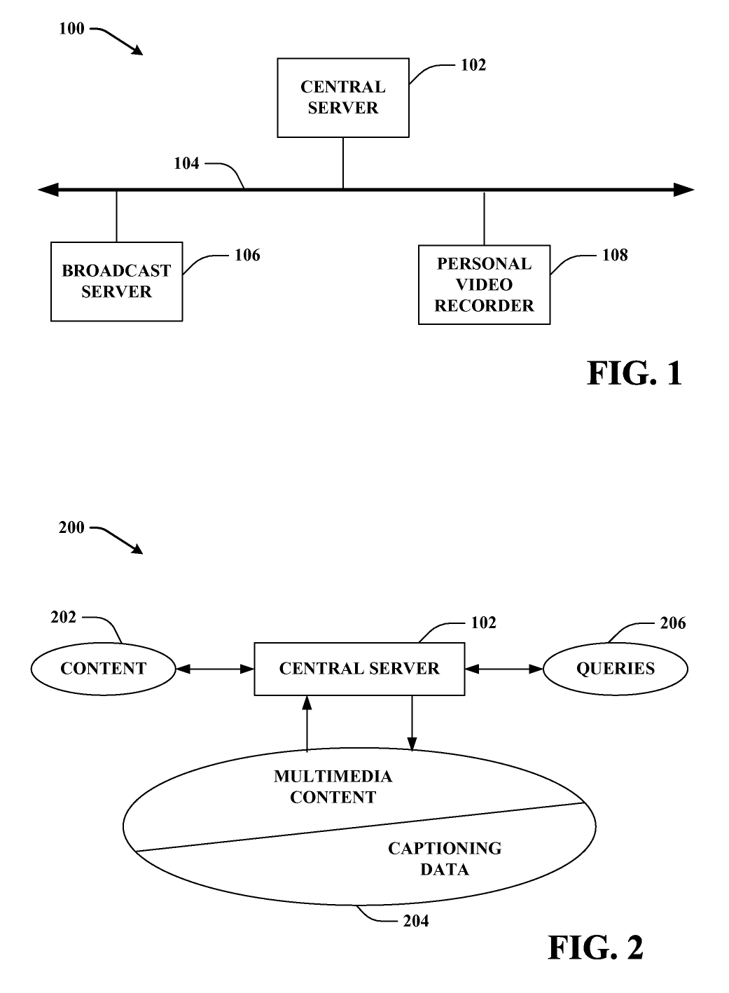

FIG. 1 illustrates a system 100 that facilitates and effectuates media content searches. System 100 can include central server 102 that searches and extracts (e.g., separates) closed captioning information from associated multimedia content thus separating incoming multimedia content into two streams—a closed captioning stream and a purely multimedia content stream—which can subsequently be persisted onto one or more storage media. System 100 can further include broadcast server 106 that broadcasts, simulcasts, and/or multicasts audio and/or video multimedia content, and personal video recorder 108, a device and/or component that plays back and/or records multimedia audio/visual content to associated storage media (e.g., volatile and/or nonvolatile memory that can be electronically erased and/or programmed, nonvolatile storage that persists digitally encoded data on rapidly rotating platters with magnetic and/or optically retentive surfaces and/or coatings, and/or magnetic tape). Personal video recorder 108 in addition can provide an instrumentality for a user to posit search queries for submission to central server 102. As illustrated, central server 102, broadcast server 106, and personal video recorder 108 can be in continuous and operative, or sporadic and intermittent communication with one another via network topology 104.

Network topology 104 can include any viable communication and/or broadcast technology, for example, wide and/or wireless modalities and 4/or technologies can be utilized to effectuate the claimed subject matter. Moreover, network topology 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and distribution—and/or any combination, permutation, and/or aggregation thereof.

As illustrated, central server 102 can be implemented entirely in software, hardware, and/or a combination of software and/or hardware. Further, central server 102 can be incorporated within and/or associated with other compatible components, such as devices and/or applicances that can include processors (e.g., desktop computers, laptop computers, notebook computers, cell phones, smart phones, personal digital assistants, multimedia Internet enabled mobile phones, multimedia players, and the like).

Broadcast server 106, like central server 102, can be implemented entirely in software, hardware, and/or as a combination of software and/or hardware. Further, broadcast server 106 can be any type of machine that includes a processor and is capable of effective communication with network topology 104. Illustrative machines that can comprise broadcast server 106 can include desktop computers, server class computing devices, cell phones, smart phones, laptop computers, notebook computers, Tablet PCs, consumer and/or industrial devices and/or appliances, hand-held devices, personal digital assistants, multimedia Internet mobile phones, and the like. Additionally and/or alternatively, broadcast server 106 can include television broadcast stations, and stations that broadcast, simulcast, and/or multicast audio and/or video multimedia content.

Personal video recorder 108 can be a standalone set-top box, or portable recording and/or playback device. Additionally, personal video recorder 108 can be implemented entirely in software, hardware, and/or a combination of both hardware and/or software. Moreover, personal video recorder 108 can be incorporated within and/or associated with other compatible components, such as, for instance, televisions, devices and/or appliances that can include processors, such as, desktop computers, laptop computers, notebook computers, smart phones, personal digital assistants, multimedia Internet enabled mobile phones, multimedia players, and the like.

FIG. 2 depicts system 200 that facilitates and effectuates media content searches in accordance with a further aspect of the claimed subject matter. As illustrated, system 200 includes central server 102 that can receive multimedia broadcast content 202 from a broadcast server 106. A multimedia broadcast content can include movies, live broadcast television shows, etc. together with associated closed captioning metadata descriptive of the movies, live and time delayed broadcast television shows, and the like. As will be appreciated by those cognizant in the art other dissemination technologies, such as streaming, simulcasting, and/or multicasting can also be utilized and as such will fall within the ambit, intent, and spirit of the claimed subject matter.

On receipt of multimedia broadcast content from broadcast server 106, central server 102 can separate out multimedia content (e.g., the actual video and/or audio content) from associated captioning data. Once central server 102 has separated out multimedia content from affiliated captioning data, the separated multimedia content and captioning data 204 can thereafter be persisted separately for future use.

Central server 102 can also receive queries from users employing personal video recorder 108, for example. Users utilizing personal video recorder 108 can posit queries related to various topics of interest associated with multimedia content. Central server 102, on receipt these queries can scan and search separated closed captioning information (e.g., either contemporaneously while central server 102 is receiving and separating broadcast multimedia content from closed captioning content, or from previously broadcast, persisted and separated multimedia content and closed captioning content) to locate captioning information contextually related to the submitted query. Central server 102 can thereafter identify and locate appropriate and pertinent multimedia content associated with identified captioning information for subsequent playback on personal video recorder 108 in satisfaction of the user query.

In separating and subsequently stitching, re-constituting, or re-associating multimedia content and captioned data together, links, indices, tables, arrays, queues, stacks, binary and multi-way trees, and the like can be employed to facilitate and fabricate joining of appropriate video content with pertinent captioning data.

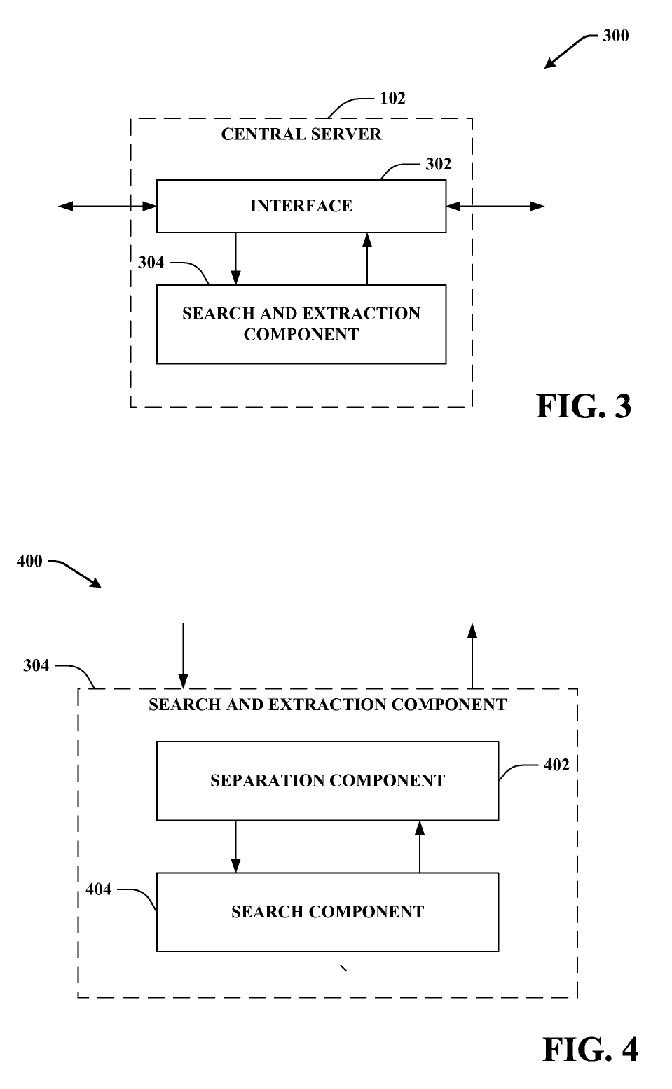

FIG. 3 provides further illustration 300 of central server 102 in accordance with an aspect of the claimed subject matter. As illustrated, central server 102 can include interface component 302 (hereinafter referred to as “interface 302”) that can be in continuous and/or intermittent communication with broadcast server 106 and personal video recorder 108 via network topology 104. Central server 102 can further include search and extraction component 304 that can receive via interface 302 data related to broadcast multimedia content, and queries from individuals utilizing personal video recorder, for subsequent separation and/or search functionalities carried out by search and extraction component 304.

Interface 302 can receive data from a multitude of sources, such as, for example, data associated with a particular multimedia broadcast presentation, client application, service, user, client, device, and/or entity involved with a particular transaction, a portion of a transaction, and thereafter convey the received information to search and extraction component 304 for subsequent analysis. To facilitate its ends, interface 302 can provide various adapters, connectors, channels, communication pathways, etc. to integrate the various components included in system 300 into virtually any operating system and/or database system and/or with one another. Additionally, interface 302 can provide various adapters, connectors, channels, communication modalities, and the like that provide for interaction with various components that can comprise system 300, and/or any other component (external and/or internal), data, and the like associated with system 300.

Search and extraction component 304 can analyze and split incoming broadcast content received by interface 302 into two streams—multimedia content (e.g., the audio and visual portion, signal, or channel associated with broadcast content) and closed captioning metadata also associated with the received broadcast content. Search and extraction component 304 can thereafter utilize various tags, index markers, links, watermarks, and other such media marking techniques to associate and establish a pertinent correlation between the separated multimedia content and fractionated closed captioning metadata, after which the separated and appropriately tagged and marked media content and closed captioning metadata can be persisted separately on one or more associate storage media.

Search and extraction component 304 can further analyze various queries received via interface 302 from individuals utilizing personal video recorder 108. Search and extraction component 304 can upon receipt of posited queries associated with simultaneously broadcast and/or previously persisted multimedia content can undertake lexical analysis of the received query and thereafter utilize the resultant tokens and/or lexemes to search through the streaming live broadcast closed captioning metadata and/or the persisted closed captioned metadata to identify pertinent closed captioning metadata contextually related to the submitted query. Where search and extraction component 304 is able to identify contextually related closed captioned metadata, the search and extraction component 304 can utilize tags, markers, links, etc. to locate and associate multimedia content correlative to the identified closed captioned metadata for subsequent display to the user on an audio and/or visual display affiliated with personal video recorder 108, for instance.

FIG. 4 provides a more detail depiction 400 of search and extraction component 304. As illustrated, search and extraction component 304 can include separation component 402 that effectuates separation of incoming live broadcast multimedia content into distinct audio/visual content and closed captioning metadata, and search component 404 that facilitates search and reconstitution of pertinent but distinct audio/visual content and correlative closed captioning metadata in response to queries submitted by users of the system.

Separation component 402 can on receipt of incoming broadcast multimedia content can fractionate the content into two constituent parts, tagging, indexing and otherwise marking each of the separated components (e.g., correlating each of the separated components frame by frame) with indicators that can expedite contemporaneous and/or subsequent search and reconstitution of pertinent media fragments and closed captioning segments in response to one or more queries that can be received from users of the system, and in particular, individuals utilizing personal video recorder 108. Separation component 402 can, once separation and appropriate marking of the separated parts has completed, store the separated portions to storage media confederated with central server 102. It will be understood by those conversant in the art that storage media confederated with central server 102 can be in close proximity and/or physically attached and/or associated with central server 102, and/or may be dispersed throughout the entirety of network topology 104.

Search component 404, upon receipt of queries from individuals utilizing personal video recorder 108, can perform lexical analysis on the queries and thereafter use the generated tokens and lexemes to locate closed captioning metadata contextually related to the submitted queries. On locating and identifying appropriate closed captioned metadata, search component 404 can utilize tags, indexing and other marking indicators associated with the closed captioned metadata segments to quickly locate, and re-constitute and associate correspondent media content fragments related to the submitted query for display or playback on appropriate display and playback instrumentalities associated with personal video recorder 108, for example.

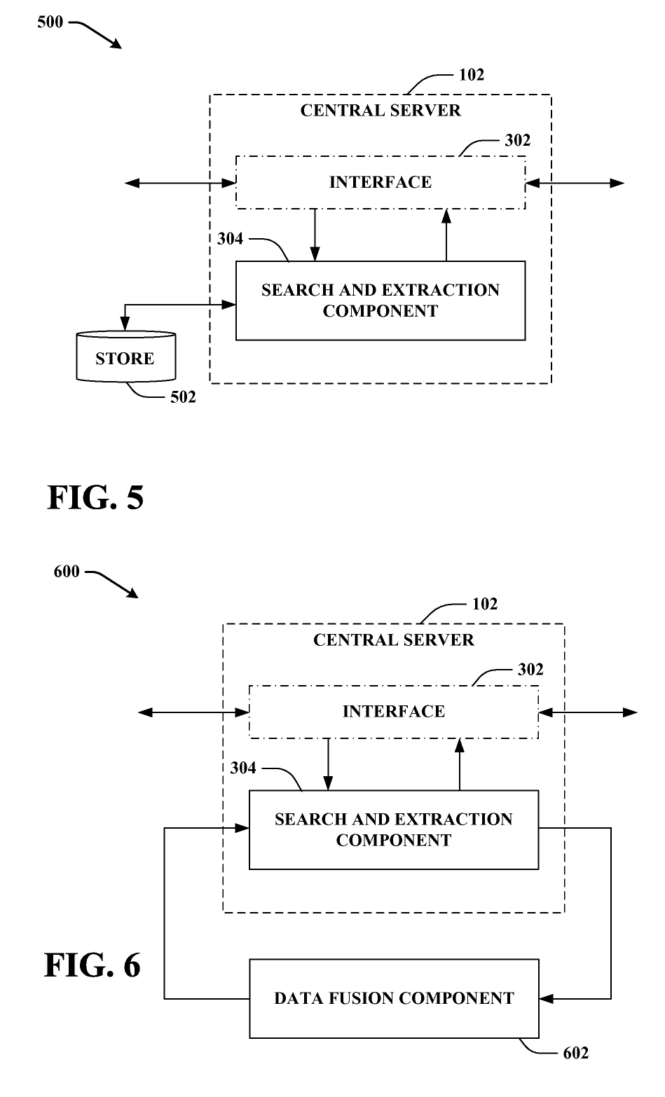

FIG. 5 depicts an aspect of a system 500 facilitates and effectuates media content searches. System 500 can include central server 102 that can comprise interface 302 and search and extraction component 304. Additionally, system 500 can include store 502 that can include any suitable data necessary for search and extraction component 304 to facilitate it aims. For instance, store 502 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate network, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information gleaned from the disparate network, ratings from a website, a credit score, geographical location, a donation to charity, or any other information related to software, applications, web conferencing, and/or any suitable data related to transactions, etc.

It is to be appreciated that store 502 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM) and Rambus dynamic RAM (RDRAM). Store 502 of the subject systems and methods is intended to comprise, without being limited to, these and any other suitable types of memory. In addition, it is to be appreciated that store 502 can be a server, a database, a hard drive, and the like.

FIG. 6 provides yet a further depiction of a system 600 that effectuates and facilitates media content searches in accordance with an aspect of the claimed subject matter. As depicted, system 600 can include a data fusion component 602 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by data fusion component 602 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

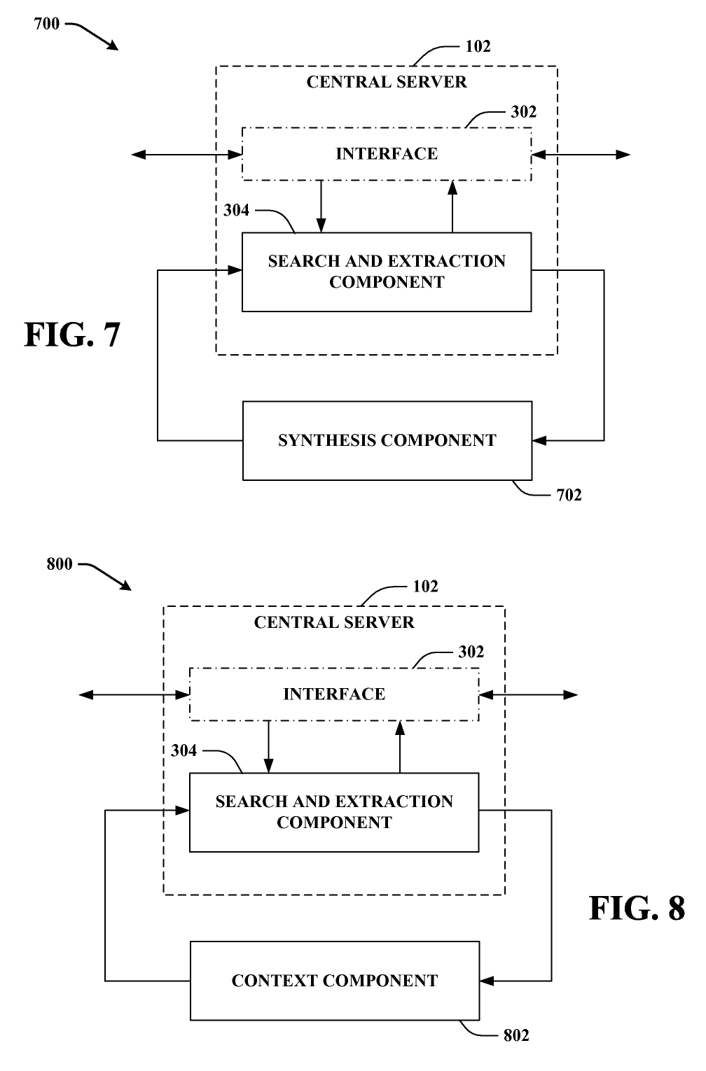

FIG. 7 provides a further depiction of a system 700 that facilitates and effectuates media content searches in accordance with an aspect of the claimed subject matter. As illustrated search and extraction component 304 can, for example, employ synthesizing component 702 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Synthesizing component 702 through combining and filtering can provide a set of information that can be more informative, all accurate (e.g., with respect to an entity's communicative or informational goals) and information from just one or two modalities, for example. As discussed in connection with FIG. 6, the data fusion component 602 can be employed to learn correlations between different data types, and the synthesizing component 702 can employ such correlations in connection with combining, or filtering the input data.

FIG. 8 provides a further illustration of a system 800 that can facilitates and effectuates media content searches in accordance with an aspect of the claimed subject matter. As illustrated search and extraction component 304 can, for example, employ context component 802 to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component 802 can provide current or historical data in connection with inputs to increase proper interpretation of inputs. For example, time of day may be helpful to understanding an input—in the morning, the word “drink” would likely have a high a probability of being associated with coffee, tea, or juice as compared to be associated with a soft drink or alcoholic beverage during late hours. Context can also assist in interpreting uttered words that sound the same (e.g., steak and, and stake). Knowledge that it is near dinnertime of the user as compared to the user campaign would greatly help in recognizing the following spoken words “I need a steak/stake”. Thus, if the context component 802 had knowledge that the user was not camping, and that it was near dinnertime, the utterance would be interpreted as “steak”. On the other hand, if the context component 802 knew (e.g., via GPS system input) that the user recently arrived at a camping ground within a national park; it might more heavily weight the utterance as “stake”.

In view of the foregoing, it is readily apparent that utilization of the context component 802 to consider and analyze extrinsic information can substantially facilitate determining meaning of sets of inputs.

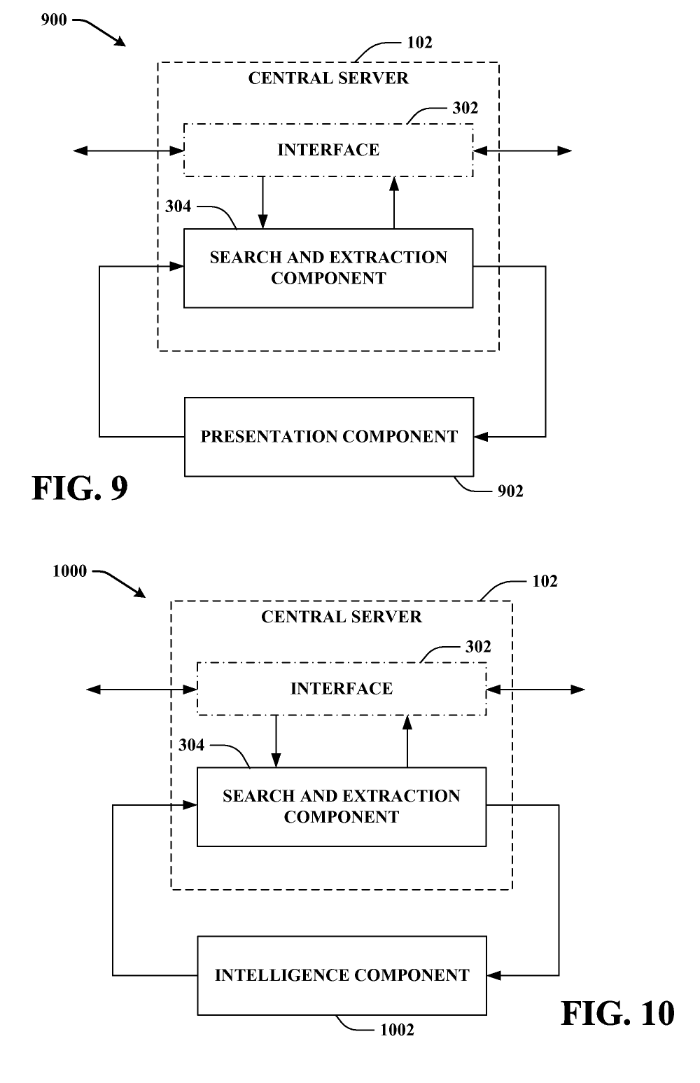

FIG. 9 a further illustration of a system 900 that facilitates and effectuates media content searches in accordance with an aspect of the claimed subject matter. As illustrated, system 900 can include presentation component 902 that can provide various types of user interface to facilitate interaction between a user and any component coupled to search and extraction component 304. As illustrated, presentation component 902 is a separate entity that can be utilized with search and extraction component 304. However, it is to be appreciated that presentation component 902 and/or other similar view components can be incorporated into search and extraction component 304 and/or a standalone unit. Presentation component 902 can provide one or more graphical user interface, command line interface, and the like. For example, the graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into search and extraction component 304.

Users can also interact with regions to select and provide information via various devices such as a mouse, roller ball, keypad, keyboard, and/or voice activation, for example. Typically, the mechanism such as a push button or the enter key on the keyboard can be employed subsequent to entering the information in order to initiate, for example, a query. However, it is to be appreciated that the claimed subject matter is not so limited. For example, nearly highlighting a checkbox can initiate information conveyance. In another example, a command line interface can be employed. For example, the command line interface can prompt (e.g., via text message on a display and an audio tone) the user for information via a text message. The user can then provide suitable information, such as alphanumeric input corresponding to an option provided in the interface prompt or an answer to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

FIG. 10 depicts a system 1000 that employs artificial intelligence to facilitate and effectuate media content searches in accordance with an aspect of the subject matter as claimed. Accordingly, as illustrated, system 1000 can include an intelligence component 1002 that can employ a probabilistic based or statistical based approach, for example, in connection with making determinations or inferences. Inferences can be based in part upon explicit training of classifiers (not shown) before employing system 100, or implicit training based at least in part upon system feedback and/or users previous actions, commands, instructions, and the like during use of the system. Intelligence component 1002 can employ any suitable scheme (e.g., numeral networks, expert systems, Bayesian belief networks, support vector machines (SVMs), Hidden Markov Models (HMMs), fuzzy logic, data fusion, etc.) in accordance with implementing various automated aspects described herein. Intelligence component 1002 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

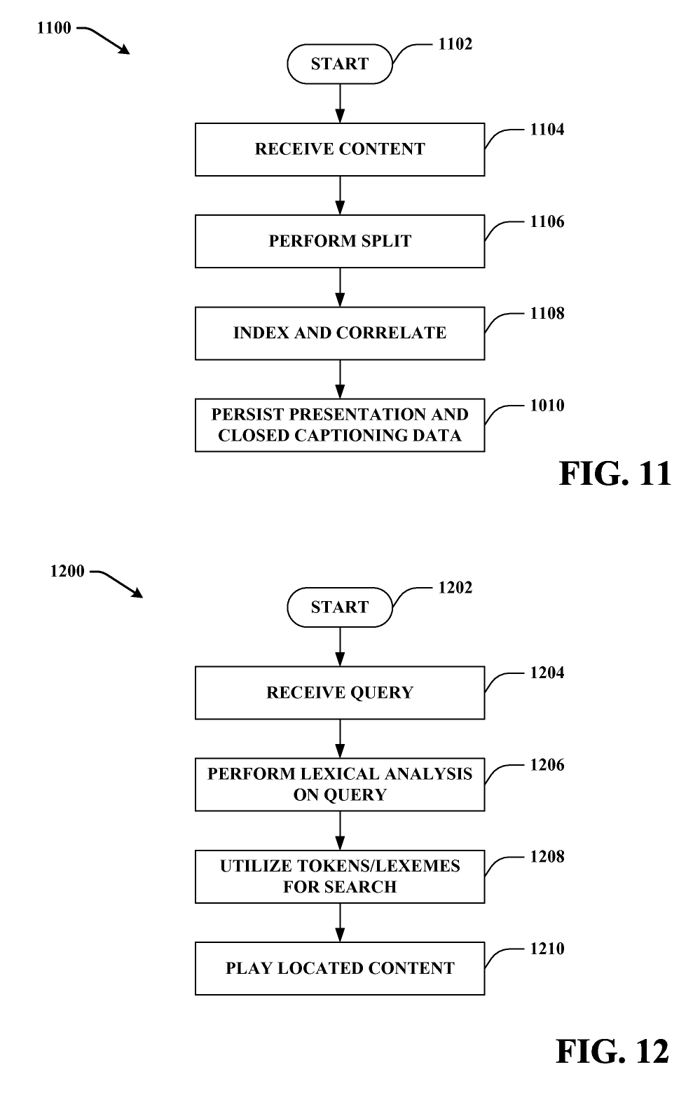

In view of the exemplary systems shown and described supra, methodologies that may be implemented in accordance with the disclosed subject matter will be better appreciated with reference to the flow chart of FIGS. 11 and 12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 11 provides an illustrative flow diagram of the machine implemented methodology 1100 that facilitates and effectuates media content searches in accordance with an aspect of the claimed subject matter. At 1102 various and sundry initialization tasks and processes can be undertaken after which method 1100 can proceed to 1104. At 1104 the method receives a multimedia content from one or more broadcast service dispersed over a network topology. At 1106 the methodology separates out multimedia content (e.g., actual video and/or audio content) from associated closed captioning metadata. At 1108 the method can, frame by frame, associate various tags, indexes, indicators, markers, and the like to each of the separated content (e.g., separated multimedia content and closed captioning metadata). Such associated tags, indexes, indicators, marker, etc. can be useful to expedite contemporaneous and/or subsequent search and reconstitution of multimedia media fragments and closed captioning metadata segments in response to queries that can have been received from individuals employing personal video recorders. At 1110 separated and appropriately indicated content can be persisted on various storage media for future utilization.

FIG. 12 provides a further illustrative flow diagram of the machine implemented methodology 1200 that facilitates and effectuates media content searches in accordance with yet another aspect of the claimed subject matter. At 1202 various initialization tasks and processes can take place after which method 1200 can proceed to 1204. At 1204 a query can be received, for example, from one or more personal video recorders, or more particularly, from individuals utilizing the one or more personal video recorders. At 1206 the method can perform lexical analysis on the received query wherein a query can be parsed to generate a plethora of tokens and lexemes. At 1208 the tokens and lexemes can be utilized to search through currently broadcasting but fractionated closed captioning metadata and/or previously persisted and separated closed captioning metadata to locate and identify closed captioned metadata contextually related to the submitted query. Upon locating and identify appropriate closed captioned metadata, the method can employ various tags, indexes and other markers associated with the identified closed captioned metadata to find an associated correspondent tag, index, and other marker commensurately and correspondingly associated with multimedia content (e.g., audio and/or visual content) to reconstitute or stitched together the closed captioned metadata and the correspondent multimedia content for subsequent playback at 1210.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g., methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

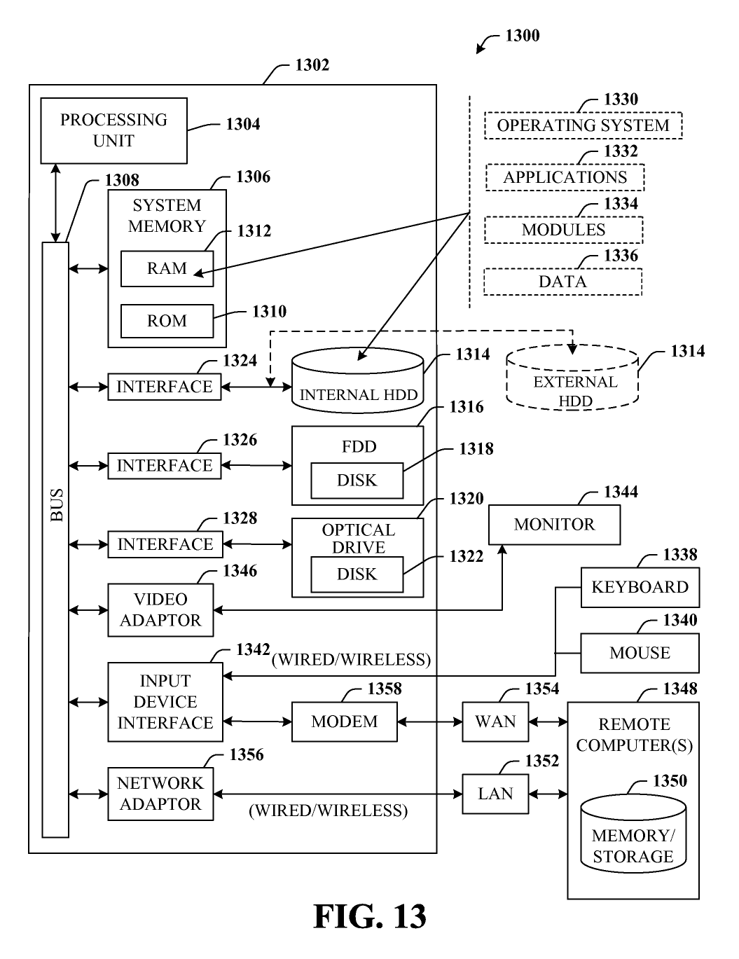

Referring now to FIG. 13, there is illustrated a block diagram of a computer operable to execute the disclosed system. In order to provide additional context for various aspects thereof, FIG. 13 and the following discussion are intended to provide a brief, general description of a suitable computing environment 1300 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 13, the exemplary environment 1300 for implementing various aspects includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that the claimed subject matter can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

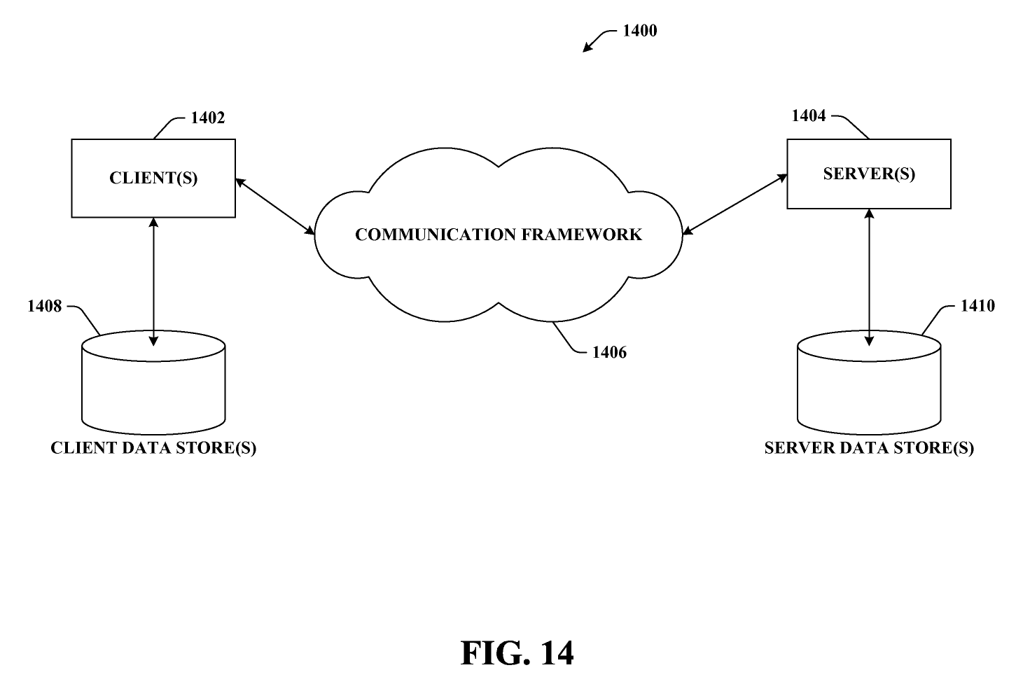

Referring now to FIG. 14, there is illustrated a schematic block diagram of an exemplary computing environment 1400 for processing the disclosed architecture in accordance with another aspect. The system 1400 includes one or more client(s) 1402. The client(s) 1402 can be hardware and/or software (e.g., threads, processes, computing devices). The client(s) 1402 can house cookie(s) and/or associated contextual information by employing the claimed subject matter, for example.

The system 1400 also includes one or more server(s) 1404. The server(s) 1404 can also be hardware and/or software (e.g., threads, processes, computing devices). The servers 1404 can house threads to perform transformations by employing the claimed subject matter, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that effectuates and facilitates search of multimedia content, comprising:
a component that extracts closed captioned information, metadata, or tags from video content received from an interface, the component indexes the extracted information against frames of corresponding video content, and utilizes the metadata, tags, and indexes to search the extracted information and respond to a submitted query.

2. The system of claim 1, the component separates closed captioned information and video content into two streams.

3. The system of claim 1, the component associates metadata, tags, or watermarks with each item of closed captioned information or each frame of corresponding video content.

4. The system of claim 1, the component selectively identifies closed captioned information based on the submitted query.

5. The system of claim 4, the component utilizes metadata, tags, or watermarks associated with the selectively identified closed captioned information to identify and locate correspondent metadata, tags, or watermarks confederated with selected portions of the corresponding video content, the selected portion of the corresponding video content supplied as a response to the submitted query.

6. The system of claim 1, the submitted query relates at least in part to video content that is currently being broadcast.

7. The system of claim 1, the submitted query relates at least in part to video content that previously was broadcast and persisted separately by component.

8. The system of claim 1, the component upon receipt of the submitted query tokenizes the submitted query, and employs the tokenized query to locate closed captioned information, metadata, or tags contextually related to the submitted query.

9. A machine implemented method that facilitates and effectuates search of media content, comprising:
extracting closed captioned information associated with video content supplied by a broadcast service;
indexing the closed captioned information against frames corresponding to the video content; and
responding to a submitted query with selected frames corresponding to the video content related to the query.

10. The method of claim 9, the closed captioned information includes metadata, links, watermarks, or flags.

11. The method of claim 9, the indexing further includes associating a unique correspondent pair of identifiers to each datum of closed captioning information and each frame corresponding to the video content.

12. The method of claim 11, the unique correspondent pair of identifiers employed during the responding to locate the selected frames corresponding to the video content.

13. The method of claim 9, further includes persisting the closed captioned information and the video content separately.

14. The method of claim 9, further includes parsing the submitted query into tokens or lexemes.

15. The method of claim 14, further includes identifying closed captioned information based on the tokens or lexemes.

16. The method of claim 9, the submitted query relates to video content being currently broadcast or video content previously persisted.

17. The method of claim 9, the responding further includes simultaneously locating video content from currently broadcast or previously persisted video content based at least in part on the submitted query.

18. A media content search system implemented on a machine, comprising:
a component that examines video content received from an interface, extracts searchable content from the video content, indexes the video content as a function of the extracted searchable content, and based upon a received query, the component responds by searching across indexed video content, and identifies video content relevant to the query.

19. The system of claim 18, the component stores searchable content separately from indexed video content.

20. The system of claim 18, the component initiates playback of identified indexed video content on a handheld device.
